(19) United States
(12) Patent Application Publication
(10) Pub. No.: US 2015/0160772 A1
(43) Pub. Date: Jun. 11, 2015

(54) INPUT DEVICE

(71) Applicant: KABUSHIKI KAISHA TOKAI RIKA DENKI SEISAKUSHO, Aichi (JP)

(72) Inventor: Shuichi TAKEUCHI, Aichi (JP)

(21) Appl. No.: 14/548,548

(22) Filed: Nov. 20, 2014

(30) Foreign Application Priority Data
Dec. 11, 2013 (JP) 2013-255997

(51) Int. Cl. G06F 3/041

(52) U.S. Cl. CPC G06F 3/0414

(57) ABSTRACT

An input device includes a display to display an operation object on a display screen, a touch sensor to output an operation signal based on a touch location on an operation surface corresponding to the display screen of the display, a vibrator to ultrasonic-vibrate the operation surface based on a vibration control signal, and a controller to receive the operation signal and output a first vibration control signal to vibrate the vibrator at a first vibration frequency when the touch location is out of a region corresponding to the operation object on the display screen or outputs a second vibration control signal to vibrate the vibrator at a second vibration frequency different from the first vibration frequency when the touch location is within the region.

The present application is based on Japanese patent application No.2013-255997 filed on Dec. 11, 2013, the entire contents of which are incorporated herein by reference.

### BACKGROUND OF THE INVENTION

1. Field of the Invention

The invention relates to an input device used to control the operation of an in-vehicle device such as an air conditioner, an audio device and a navigation system.

2. Description of the Related Art

An input device is known which assists a user to perform an input operation by changing friction resistance on an operation surface of a touchpad (see e.g. JP-A-2012-69048).

The input device is provided with a display on which functional items to execute functions of another device connected thereto are displayed in the form of buttons, a touchpad configured that an operation position thereon corresponds to an indicated position in the image on the display, a piezoelectric element provided on the back side of the touchpad to vibrate the touchpad by a high-frequency wave, and a control unit which detects an operation position on the touchpad touched by a finger of a user and controls so that the piezoelectric element vibrates the touchpad when the indicated position on the display corresponding to the operation position is on a functional item, and does not vibrate the touchpad in other cases.

### SUMMARY OF THE INVENTION

The input device disclosed in JP-A-2012-69048 is constructed such that a difference in friction resistance with the operation surface allows a user to distinguish the outside and inside of the functional item area when the finger of the user travels from the outside toward the inside of the functional item area, crossing a boundary therebetween.

However, a problem may arise that the friction resistance to be felt inside the item area varies and is unstable depending on the moving speed of the finger of the user and this makes the user uncomfortable during the operation.

It is an object of the invention to provide an input device that provides the user with a steady operational feeling however the user operates it.

(1) According to one embodiment of the invention, an input device comprises:
a display to display an operation object on a display screen;
a touch sensor to output an operation signal based on a touch location on an operation surface corresponding to the display screen of the display;
a vibrator to ultrasonic-vibrate the operation surface based on a vibration control signal; and
a controller to receive the operation signal and output a first vibration control signal to vibrate the vibrator at a first vibration frequency when the touch location is out of a region corresponding to the operation object on the display screen or outputs a second vibration control signal to vibrate the vibrator at a second vibration frequency different from the first vibration frequency when the touch location is within the region.

In the above embodiment (1) of the invention, the following modifications and changes can be made.

(i) The first vibration frequency is more than the second vibration frequency.

(ii) The controller changes the first and/or second vibration frequency so as to reduce a difference between the first and second vibration frequencies according as a moving speed of the touch location increases.

(iii) The controller keeps the first vibration frequency unchanged and increases the second vibration frequency according as a moving speed of the touch location increases.

(iv) The controller keeps the second vibration frequency and decreases the first vibration frequency according as a moving speed of the touch location increases.

(v) The vibrator stops vibrating when the touch location is within the region.

(vi) The first vibration frequency is less than the second vibration frequency.

### ADVANTAGEOUS EFFECTS OF THE INVENTION

According to one embodiment of the invention, an input device can be provided that provides the user with a steady operational feeling however the user operates it.

### BRIEF DESCRIPTION OF THE DRAWINGS

Next, the present invention will be explained in more detail in conjunction with appended drawings, wherein:

FIG. 1 is a schematic view showing a configuration example of an input device;

FIGS. 2A to 2C are explanatory graphical representations showing an example of an operation of the input device; and

FIGS. 3A to 3C are explanatory graphical representations showing another example of an operation of the input device.

### DETAILED DESCRIPTION OF THE PREFERRED EMBODIMENT

### Embodiment

### Configuration of Input Device

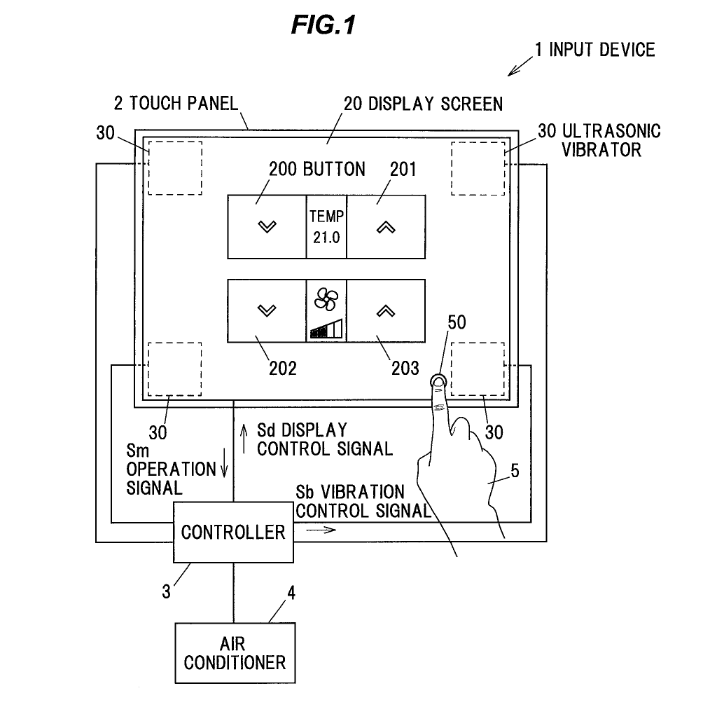

FIG. 1 is a schematic view showing a configuration example of an input device.

In FIG. 1, a typical input device in the embodiment is generally indicated by the reference numeral 1 and is schematically illustrated. The input device 1 is used for, but not specifically limited to, controlling an operation of, e.g., an in-vehicle device which is an air conditioner 4 here, and may be used for controlling an operation of an audio device or a navigation system, etc.

The input device 1 has a controller 3 for controlling an operation of the air conditioner 4, a touch panel 2 provided with a display as a display means for displaying a control screen, etc., of the air conditioner 4 and a touch sensor as an input means formed of a transparent or semi-transparent material so as not to block the image on the display and provided on the display to output an operation signal Sm in accordance with a touch operation on an operation surface, and ultrasonic vibrators 30 provided on the back side of the touch panel 2 to apply vibration to the touch panel 2. The controller 3, which operates based on the operation signal Sm output from the touch panel 2, controls images displayed on the touch panel 2 by a display control signal Sd and also controls the ultrasonic vibrators 30 by a vibration control signal Sb.

The input device 1 in the illustrated example is arranged so that, e.g., the touch panel 2 is located on a dash panel or around a driver's seat such as on a center console.

The input device 1 is configured so that, when the touch panel 2 is touch-operated by a finger 5 of a user, a position of, e.g., a contact point 50 on a surface of the touch panel 2 is detected by the touch sensor, the operation signal Sin corresponding to the detected position is input to the controller 3 to select one of buttons 200 to 203 on the touch panel 2 and the controller 3 controls the air conditioner 4 according to the selection.

In the touch panel 2, a control screen of the air conditioner 4 including the plural buttons 200 to 203 as operation objects is displayed on a display screen 20. The arrangement of the buttons 200 to 203 is not specifically limited to that shown in the drawing.

As an example, the buttons 200 and 201 on the display screen 20 have functions of turning up and down the temperature and the buttons 202 and 203 have functions of increasing and decreasing the air volume. The touch panel 2 may alternatively display a control screen of a navigation system, or may display control screens of plural in-vehicle devices on the same screen.

Note that, coordinates of an indicated position in the display screen 20 of the touch panel 2 and coordinates of the contact point 50 on the touchpad of the touch panel 2 are in an absolute coordinate system in a one-to-one correspondence manner. Alternatively, the display and the touch sensor of the touch panel 2 may be provided separately.

The ultrasonic vibrator 30 is configured to generate an ultrasonic vibration by applying AC voltage to a piezoelectric element formed of a piezoelectric material such as piezoelectric ceramics, piezoelectric polymer membrane or piezoelectric film, and is controlled to vibrate based on the vibration control signal Sb output from the controller 3 when the controller 3 determines that the contact point 50 is located in an area other than the areas of the buttons 200 to 203, and to stop vibration (or to reduce a vibration frequency) when it is determined that the contact point 50 is located within the area of the button 200 to 203. Here, the vibration is ultrasonic vibration at a frequency of not less than 20 kHz. Alternatively, a piezoelectric element which can change resonant frequency to generate vibrations with different frequencies may be used, or plural ultrasonic vibrators with different resonant frequencies may be prepared.

Although a display/operation surface of the touch panel 2 shown in the drawing has a rectangular shape, an arbitrary shape composed of curved lines and straight lines can be selected or a display/operation surface may be divided into plural sections.

### Operation in the Embodiment

Two patterns of operation of the input device 1, which are (1) Operation of imparting an uneven feeling and (2) Operation of imparting a uniform uneven feeling, will be separately described below in reference to FIGS. 1 to 3C.

(1) Operation of Imparting an Uneven Feeling

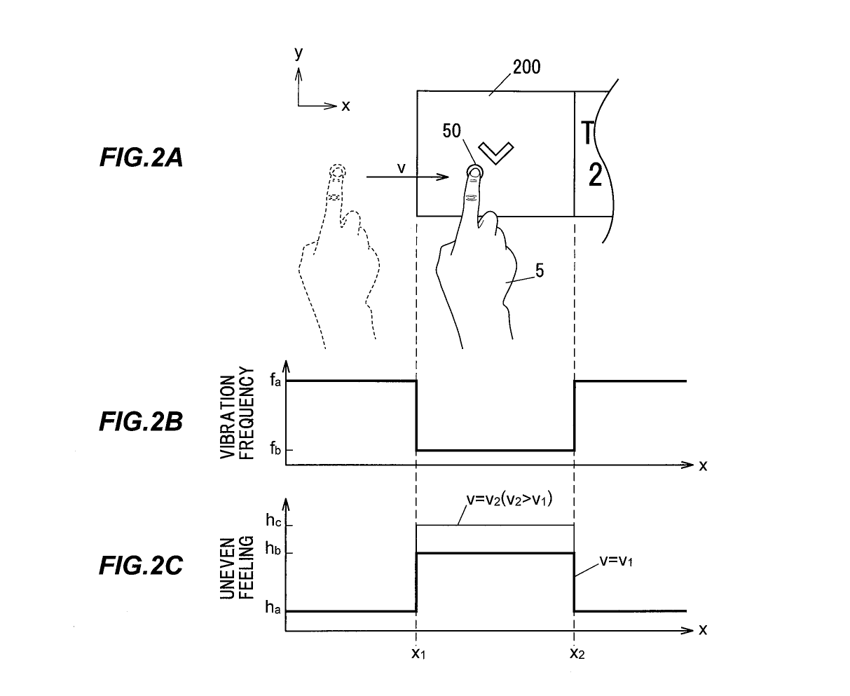

FIGS. 2A to 2C are explanatory graphical representations showing an example of an operation of the input device 1.

Here, the upward direction in FIG. 2A is defined as the y-axis direction and the rightward direction in the drawing is defined as the x-axis direction. Note that, although an operation with respect to the button 200, among the buttons 200 to 203, will be representatively described below, the same applies to the other buttons 201 to 203.

An operation shown in FIG. 2A will be described as an example. The button 200 is present in the region of x₁≦x≦x₂ and the finger 5 of the user travels in the x-direction from the outside of the area of the button 200 (x<x₁) to the inside of the area of the button 200 (x₁≦x≦x₂) at a speed of v=v₁ while touching the operation surface of the touch panel 2.

As shown in FIG. 2B, the ultrasonic vibrator 30 vibrates at a frequency fₐ based on the vibration control signal Sb (first vibration control signal) output from the controller 3 when the contact point 50 is located out of the area of the button 200 (x<x₁, x₂<x), and vibrates at a frequency f_{b} lower than the frequency fₐ based on the vibration control signal Sb (second vibration control signal) output from the controller 3 when the contact point 50 is located within the area of the button 200 (x₁≦x≦x₂). Note that, the frequency f_{b} may be 0 so that the vibration stops.

When the operation surface of the touch panel 2 is vibrated by the ultrasonic vibrator 30, friction resistance between the finger 5 of the user and the operation surface of the touch panel 2 is reduced due to a squeezing effect as compared to the case without vibration. This is because peripheral air (or liquid) is drawn into a space between the finger 5 and the operation surface due to pressure variation caused by the vibration.

Therefore, the finger 5 of the user feels a friction resistance difference from low to high at a position around x=x₁ and this results in that an uneven feeling is imparted to the finger 5 of the user. As indicated by a thick solid line in FIG. 2C, the imparted uneven feeling is hb-ha, where ha is a height of the operation surface of the touch panel 2 which the user feels when touching the outside of the area of the button 200 (x<x₁) and hb is a height of the operation surface which the user feels when touching the inside of area of the button 200 (x₁≦x≦x₂).

On the other hand, when the finger 5 of the user travels in the x-direction from the outside of the area of the button 200 (x<x₁) to the inside of the area of the button 200 (x₁≦x≦x₂) at a speed of v=v₂ faster than the speed vi (v₁<v₂) while touching the operation surface of the touch panel 2, and in case that the ultrasonic vibrator 30 vibrates at the frequency fₐ based on the vibration control signal Sb output from the controller 3 when the contact point 50 is located out of the area of the button 200 (x<x₁, x₂<x) and vibrates at the frequency f_{b} lower than the frequency fₐ when the contact point 50 is located within the area of the button 200 (x₁≦x≦x₂) as shown in FIG. 2B in the same manner as described above, a height of the operation surface which the user feels when touching the inside of area of the button 200 (x₁≦x≦x₂) is he as indicated by a thin solid line in FIG. 2C and the imparted uneven feeling is hc-ha which makes the user feel a larger unevenness than at the speed v₁.

In order to impart an uneven feeling to the user more uniformly, the controller 3 may control the ultrasonic vibrator 30 as described below.

(2) Operation of Imparting a Uniform Uneven Feeling

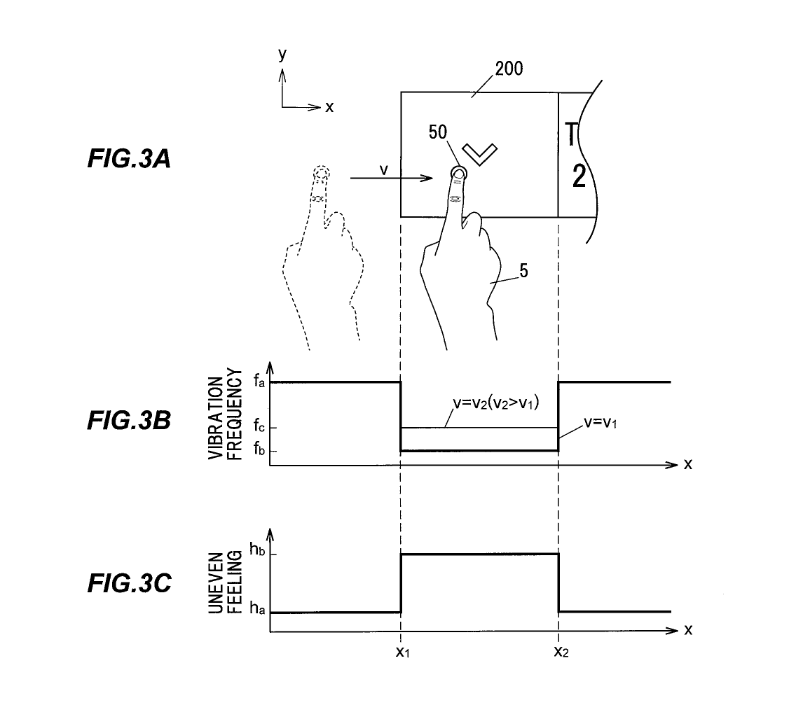

FIGS. 3A to 3C are explanatory graphical representations showing another example of an operation of the input device 1.

When the speed is v=v₁, as indicated by a thick solid line in FIG. 3B, the ultrasonic vibrator 30 vibrates at the frequency fₐ based on the vibration control signal Sb (first vibration control signal) output from the controller 3 when the contact point 50 is located out of the area of the button 200 (x<x₁, x₂<x), and vibrates at the frequency f_{b} lower than the frequency fₐ based on the vibration control signal Sb (second vibration control signal) output from the controller 3 when the contact point 50 is located within the area of the button 200 (x₁≦x≦x₂) in the same manner as described above. Meanwhile, when the speed is v=v₂, the ultrasonic vibrator 30 vibrates at a frequency f_{c}, which is lower than the frequency fₐ and higher than the frequency f_{b}, when the the contact point 50 is located within the area of the button 200 (x₁≦x≦x₂), as indicated by a thin solid line in FIG. 3B.

As a result, as indicated by a solid line in FIG. 3C, the imparted uneven feeling is evenly hb-ha at the speed vi as well as at the speed v₂, where ha is a height of the operation surface of the touch panel 2 which the user feels when touching the outside of the area of the button 200 (x<x₁) and hb is a height of the operation surface which the user feels when touching the inside of the area of the button 200 (x₁≦x≦x₂). In other words, the controller 3 adjusts the frequency f_{c} so that the imparted uneven feeling is hb-ha evenly at the speed vi as well as at the speed v₂.

### Effects of the Embodiment

In the embodiment, using the squeezing effect, the operation surface of the touch panel 2 is vibrated at the frequency fₐ based on the vibration control signal Sb output from the controller 3 when the contact point 50 between the finger 5 of the user and the operation surface of the touch panel 2 is located out of the areas of the buttons 200 to 203 and the operation surface is vibrated at the frequency f_{b} lower than the frequency fₐ when the contact point 50 is located within the area of the button 200 to 203, thereby making the finger 5 of the user feel a friction resistance difference on the operation surface from low to high at a position around the boundaries of the areas of the buttons 200 to 203. This allows an uneven feeling to be imparted to the finger S of the user and allows the user to feel as if the buttons 200 to 203 would be formed to be convex.

In addition, when the moving speed of the contact point 50 between the finger 5 of the user and the operation surface of the touch panel 2 is fast and at the same time when the contact point 50 is located within the area of the button 200 to 203, the operation surface of the touch panel 2 is vibrated at the frequency f_{c} which is lower than the frequency fₐ applied outside of the areas of the buttons 200 to 203 and higher than the frequency f_{b} applied at a low moving speed. Therefore, the uneven feeling with the uniform difference in height can be imparted to the user at a high speed as well as at a low speed.

Alternatively, at the speed of v=v₂ in FIG. 3B, the frequency may not be changed in the area of x₁≦x≦x₂ so as to remain as f=f_{b} but instead changed in the area of x<x₁ and x₂<x so as to be f=fₐ′(<fₐ) to provide a uniform unlevel feeling. In other words, one or both of the frequencies fₐ and f_{b} may be changed so as to reduce the difference therebetween. In addition, although an example in which the area of the button 200 is felt higher than the other areas has been described, the area of the button 200 may be felt lower.

### Modifications

Although the typical configuration example of the input device 1 of the invention has been described above with the embodiment and illustrated example, the following modifications can be also implemented.

(1) The input device 1 can be used not only for in-vehicle devices but also for various electronic/electrical devices.

(2) The number, positions and arrangement configuration of the input devices 1 may be appropriately selected according to, e.g., the intended use, etc.

It should be noted that the invention is not intended to be limited to the embodiment and the various kinds of modifications can be implemented without departing from or adjusting the technical idea of the invention.

What is claimed is:

1. An input device, comprising:
a display to display an operation object on a display screen;
a touch sensor to output an operation signal based on a touch location on an operation surface corresponding to the display screen of the display;
a vibrator to ultrasonic-vibrate the operation surface based on a vibration control signal; and
a controller to receive the operation signal and output a first vibration control signal to vibrate the vibrator at a first vibration frequency when the touch location is out of a region corresponding to the operation object on the display screen or outputs a second vibration control signal to vibrate the vibrator at a second vibration frequency different from the first vibration frequency when the touch location is within the region.

2. The input device according to claim 1, wherein the first vibration frequency is more than the second vibration frequency.

3. The input device according to claim 1, wherein the controller changes the first and/or second vibration frequency so as to reduce a difference between the first and second vibration frequencies according as a moving speed of the touch location increases.

4. The input device according to claim 1, wherein the controller keeps the first vibration frequency unchanged and increases the second vibration frequency according as a moving speed of the touch location increases.

5. The input device according to claim 1, wherein the controller keeps the second vibration frequency and decreases the first vibration frequency according as a moving speed of the touch location increases.

6. The input device according to claim 1, wherein the vibrator stops vibrating when the touch location is within the region.

7. The input device according to claim 1, wherein the first vibration frequency is less than the second vibration frequency.
